(19) United States
(12) Patent Application Publication
(10) Pub. No.: US 2025/0259461 A1
(43) Pub. Date: Aug. 14, 2025

(54) METHOD FOR ACCURATELY MEASURING LIVE SPERM MORPHOLOGY

(71) Applicant: SUZHOU BOUNDLESS MEDICAL TECHNOLOGY CO., LTD., Suzhou (CN)

(72) Inventors: Zongjie HUANG, Suzhou (CN); Chunfeng YUE, Suzhou (CN); Wenyuan CHEN, Suzhou (CN); Changsheng DAI, Suzhou (CN); Aojun JIANG, Suzhou (CN); Miao HAO, Suzhou (CN); Rongan ZHAI, Suzhou (CN)

(73) Assignee: SUZHOU BOUNDLESS MEDICAL TECHNOLOGY CO., LTD., Suzhou (CN)

(21) Appl. No.: 19/192,273

(22) Filed: Apr. 28, 2025

Related U.S. Application Data
(63) Continuation of application No. PCT/CN2022/142159, filed on Dec. 27, 2022.

(30) Foreign Application Priority Data
Nov. 28, 2022 (CN) 202211505321.8

(51) Int. Cl. G06V 20/69; G06T 7/155; G06T 7/64; G06V 10/82

(52) U.S. Cl. CPC G06V 20/698; G06T 7/155; G06T 7/64; G06V 10/82; G06V 20/695; G06T 2207/20036; G06T 2207/30024

(57) ABSTRACT

The present invention provides a method for accurately measuring live sperm morphology, including the following steps: S11. acquiring an image including a plurality of sperm cells; S12. detecting the sperm cells in the image, and segmenting a head, a midpiece, and a tail of each detected sperm cell; and S13. calculating morphological parameters of each sperm cell based on a segmentation result. For the method for accurately measuring live sperm morphology of the present invention, an image of sperm cells is acquired, a head, a midpiece, and a tail of each sperm cell are segmented through image processing, and morphological parameters of each sperm cell are calculated based on a segmentation result. Morphological parameters of live sperm cells can be comprehensively and accurately obtained for analysis or selection.

### CROSS-REFERENCE TO RELATED APPLICATIONS

This application is a continuation of International Application No. PCT/CN2022/142159 filed on Dec. 27, 2022, which claims priority to Chinese Patent Application No. CN 202211505321.8 filed on Nov. 28, 2022. The disclosures of the above-referenced applications are hereby incorporated by reference in their entirety.

### BACKGROUND

According to statistical data from the World Health Organization (WHO), approximately 48 million couples and 186 million individuals worldwide suffer from infertility. In vitro fertilization (IVF) treatment has been widely applied in addressing infertility. According to data from the Society for Assisted Reproductive Technology (SART), 1 million infants were born in the United States from 1987 to 2015 through the assistance of IVF or other assisted reproductive technologies.

Sperm morphology detection plays a critical role in IVF, for example, diagnosing male infertility through semen analysis and selecting an individual sperm cell for intracytoplasmic sperm injection (ICSI). Sperm morphology measurement involves parameters related to shapes and sizes of a head, a midpiece, and a tail of a sperm cell. Sperm with morphological abnormalities may lead to lower fertilization rates, implantation rates, and pregnancy rates. The WHO further reports that subcellular structures such as a nucleus, an acrosome, and a vacuole (within the head of the sperm cell) are essential for sperm quality evaluation. For example, vacuoles originate from abnormal chromatin condensation and may indicate the degree of DNA fragmentation in sperm.

Due to the rapid motility of normal human sperm (e.g., >25 μm/s), it is essential to use a larger field of view at a low magnification to measure kinematic parameters of sperm during semen analysis and sperm selection for ICSI. Although morphological parameters such as shapes and sizes of cells can be measured at low magnification (e.g., 20× or 40×), accurate detection of subcellular structures in sperm requires high magnification (e.g., 100×) only after invasive staining procedures that kill the sperm. Such processed sperm cannot be utilized for therapeutic purposes.

In clinical practice, cellular morphological parameters are estimated by embryologists through visual observation of live sperm, while detailed information regarding subcellular morphological parameters cannot be accurately visualized and is consequently neglected. However, this qualitative estimation exhibits high subjectivity and inconsistency, and the neglect of subcellular morphological parameters restricts the accurate evaluation and selection of sperm. Therefore, quantitative measurement of both cellular and subcellular morphology is essential for the analysis of live sperm and sperm selection in IVF.

In U.S. Pat. No. 8,390,681B1, a portion of a semen sample is stained and subjected to morphological measurements under a microscope at a high magnification, and another portion of the semen sample is used for motility measurements or selection under the microscope at a low magnification. However, since the assessments of morphology and motility are not conducted on the same sperm cell, such sperm quality analysis is incomplete and suboptimal. During sperm selection, there is no guarantee that a selected sperm cell possesses both favorable motility and morphological parameters.

In U.S. patent application No. 20090202131A1, CN104268515A, and WO2005080944 A1, methods for measuring cell-level sperm morphology through conventional image processing are disclosed. In these methods, the morphology (e.g., the head) of a sperm cell is detected via edge detection or thresholding based on image gradients or variations in pixel intensity. However, these methods fail to separate overlapping sperm.

U.S. Pat. No. 10,991,097B2 and CN103984958A disclose methods utilizing convolutional neural networks (CNNs) for automatic cell segmentation (e.g., cancer cells) in biomedical imaging. However, these methods can only distinguish cell types (e.g., cancer cells and white blood cells) from input images but fail to differentiate variations among cells of the same type. In addition, these methods are designed to segment targets as a whole without distinguishing their substructures.

In summary, existing methods fail to achieve accurate measurement of live sperm morphology.

### SUMMARY

The present invention relates to the field of sperm morphology measurement technologies, and in particular, to a method for accurately measuring live sperm morphology.

A technical problem to be resolved by the present invention is to provide a method for accurately measuring live sperm with high accuracy and practical feasibility.

To resolve the foregoing problem, the present invention provides a method for accurately measuring live sperm morphology, including the following steps:
S11. acquiring an image including a plurality of sperm cells;
S12. detecting the sperm cells in the image, and segmenting a head, a midpiece, and a tail of each detected sperm cell; and
S13. calculating morphological parameters of each sperm cell based on a segmentation result.

In an embodiment of the present invention, Step S12 includes: detecting the sperm cells in the image using a sperm parsing CNN, and segmenting the head, the midpiece, and the tail of each detected sperm cell, where the sperm parsing CNN includes a detection module and a segmentation module;
the detection module is configured to extract features from the image using a convolutional backbone architecture, and scale sizes of the extracted features using a feature pyramid network (FPN) to generate scaled feature maps, and is further configured to propose various candidate bounding boxes for the scaled feature maps using a region proposal network (RPN), and pass proposed regions of interest (ROIs) to a bounding box branch for bounding box regression; and
the segmentation module is configured to fuse the scaled feature maps to generate a fused feature map, crop a corresponding region in the fused feature map using a bounding box calculated by the bounding box branch, and finally input the cropped region in the fused feature map into a mask branch for part segmentation to segment the head, the midpiece, and the tail of the sperm cell.

In an embodiment of the present invention, the morphological parameters of the sperm cell include a size of the head of the sperm cell, ellipticity of the head of the sperm cell, regularity of the head of the sperm cell, a size of the midpiece of the sperm cell, a bending angle of the midpiece of the sperm cell, an angle between the head and the midpiece of the sperm cell, a length of the tail of the sperm cell, and a degree of deformities of the tail of the sperm cell.

In an embodiment of the present invention, a contour of the head of the sperm cell is fitted to generate an ellipse, lengths of a major axis and a minor axis of the fitted ellipse respectively represent a length and a width of the head of the sperm cell, and the size of the head of the sperm cell is obtained based on the length and the width of the head of the sperm cell; the regularity of the head of the sperm cell is calculated using a mean value of all distances between all points on the contour of the head of the sperm cell and the fitted ellipse;
a width of the midpiece of the sperm cell is obtained by calculating a mean distance from all points on a contour of the midpiece to a corresponding centerline;
tangential directions of line segments on the centerline of the midpiece are calculated, and then a maximum variation quantity of tangential directions of adjacent line segments is calculated as the bending angle of the midpiece;
a distance from each point on the contour of the head of the sperm cell to each point on the contour of the midpiece of the sperm cell is first calculated; then a pair of closest points is found on the contour of the head of the sperm cell and the contour of the midpiece of the sperm cell and designated as connecting points; distances from the points on the contour of the head of the sperm cell and the points on the contour of the midpiece of the sperm cell to the connecting points are calculated, and farthest points are recorded; connecting lines between the connecting points and the farthest points on the head of the sperm cell and the midpiece of the sperm cell are respectively calculated, and an angle between the two lines is calculated as the angle between the head of the sperm cell and the midpiece of the sperm cell; and
the deformities of the tail of the sperm cell include tail coiling, tail bending, and width nonuniformity; the tail coiling is detected by examining width irregularities of a contour of the tail; the tail bending is detected by examining a maximum variation of tangential directions of adjacent sections on a centerline of the tail; and the width nonuniformity is detected by measuring a distribution of distances between all points on the contour of the tail of the sperm cell to the centerline of the tail.

In an embodiment of the present invention, the method further includes steps of noninvasively measuring subcellular morphological parameters of the sperm cell, where the steps include:
S21. detecting the sperm cells in the image, and cropping the head and the midpiece of each detected sperm cell, where the image is an unstained sperm image captured at a first magnification;
S22. predicting a stained sperm image of the cropped image of the head and the midpiece of the sperm cell at a second magnification, where the second magnification is greater than the first magnification; and
S23. calculating the subcellular morphological parameters of the sperm cell using the stained sperm image.

In an embodiment of the present invention, Step S22 includes: predicting the stained sperm image of the cropped image of the head and the midpiece of the sperm cell at the second magnification using a sperm virtual staining generative adversarial network (GAN), where the sperm virtual staining GAN includes a generative model and a discriminative model, the generative model is configured to generate a synthetic stained sperm image at the second magnification using the unstained sperm image captured at the first magnification, and the discriminative network is configured to evaluate whether the image is correctly synthesized.

In an embodiment of the present invention, the unstained sperm image captured at the first magnification is used as an input, and is interpolated to a same resolution during training and prediction, and the stained sperm image at the second magnification is used as an output.

In an embodiment of the present invention, the first magnification ranges from 20× to 40×, and the second magnification is greater than or equal to 100×.

In an embodiment of the present invention, the subcellular morphological parameters include an acrosome area, a nucleus area, a vacuole number, and a vacuole area, the acrosome area and the nucleus area are detected through a variation in pixel intensity, and the vacuole number and the vacuole area are detected using a pore detection algorithm.

In an embodiment of the present invention, the method further includes: classifying the subcellular morphological parameters of the sperm cell as normal or abnormal based on a CNN classification network without performing staining prediction, where the CNN classification network uses the unstained sperm image captured at the first magnification as an input, and uses a Boolean label indicating that the subcellular morphological parameters of the sperm cell are normal or abnormal as an output, and the Boolean label is generated based on the stained sperm image at the second magnification, and corresponds to the inputted unstained sperm image at the first magnification.

The beneficial effects of the invention are as follows:

For the method for accurately measuring live sperm morphology of the present invention, an image of sperm cells is acquired, a head, a midpiece, and a tail of each sperm cell are segmented through image processing, and morphological parameters of each sperm cell are calculated based on a segmentation result. Morphological parameters of live sperm cells can be comprehensively and accurately obtained for analysis or selection.

The above description is only an overview of the technical solutions of the present invention. For a clearer understanding of the technical measure of the present invention and implementation according to the content of the specification, and to make the above and other objectives, features, and advantages of the present invention clearer and more comprehensible, detailed description is provided as follows with reference to preferred embodiments and the accompanying drawings.

### BRIEF DESCRIPTION OF THE DRAWINGS

FIG. 1 is a flowchart of a method for accurately measuring live sperm morphology according to an embodiment of the present invention;

FIG. 2 is a schematic diagram of a sperm parsing CNN according to an embodiment of the present invention;

FIG. 3 is a sample image of a segmentation result of a head, a midpiece, and a tail of a sperm cell according to an embodiment of the present invention;

FIG. 4 is a schematic diagram of calculating cellular morphological parameters of a head of a sperm cell and an angle between the head and a midpiece of the sperm cell according to an embodiment of the present invention;

FIG. 5 is a flowchart of steps of noninvasively measuring subcellular morphological parameters of a sperm cell according to an embodiment of the present invention;

FIG. 6 is a cropped image of a head and a midpiece of the sperm cell according to an embodiment of the present invention;

FIG. 7 is a schematic diagram of a sperm virtual staining GAN according to an embodiment of the present invention; and

FIG. 8 is a schematic diagram of a training process of classifying subcellular morphology using unstained sperm at a first magnification according to an embodiment of the present invention.

### DETAILED DESCRIPTION

The present invention is further described below with reference to the accompanying drawings and specific embodiments, to enable a person skilled in the art to better understand and implement the present invention. However, the embodiments are not used to limit the present invention.

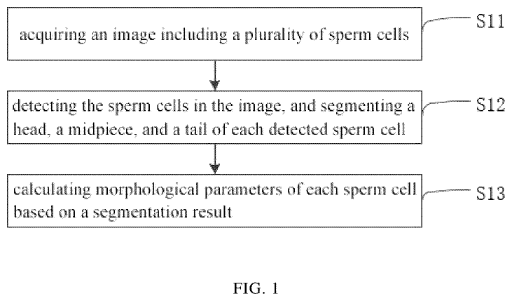

As shown in FIG. 1, this embodiment discloses a method for accurately measuring live sperm morphology, including the following steps:

Step S11. Acquire an image including a plurality of sperm cells.

Step S12. Detect the sperm cells in the image, and segment a head, a midpiece, and a tail of each detected sperm cell.

Step S13. Calculate morphological parameters of each sperm cell based on a segmentation result.

For the method for accurately measuring live sperm morphology of the present invention, an image of sperm cells is acquired, a head, a midpiece, and a tail of each sperm cell are segmented through image processing, and morphological parameters of each sperm cell are calculated based on a segmentation result. Morphological parameters of live sperm cells can be comprehensively and accurately obtained for analysis or selection.

Optionally, Step S12 includes: detecting the sperm cells in the image using a sperm parsing CNN, and segmenting the head, the midpiece, and the tail of each detected sperm cell.

Compared with a conventional CNN-based detection or segmentation network that can only detect or segment one target, when detecting a sperm cell, the sperm parsing CNN of the present invention also segments parts of the detected sperm cell. The network employed in the present invention is improved based on a classical two-stage instance segmentation network. The network detects and localizes target objects in a first stage, and segments targets based on localized ROIs in a second stage. The two-stage instance segmentation network (e.g., Mask R-CNN, Cascade R-CNN, and Hybrid Task Cascade) is a combination of a detection network and a segmentation network. However, a conventional two-stage instance segmentation network can only segment a sperm cell as a whole, and cannot segment parts (e.g., a head, a midpiece, and a tail) of the sperm cell. Therefore, in the present invention, a two-stage instance segmentation network is modified to accomplish this instance-aware part segmentation task (i.e., localization of a sperm cell in the first stage, and segmentation of a head, a midpiece, and a tail in the second stage).

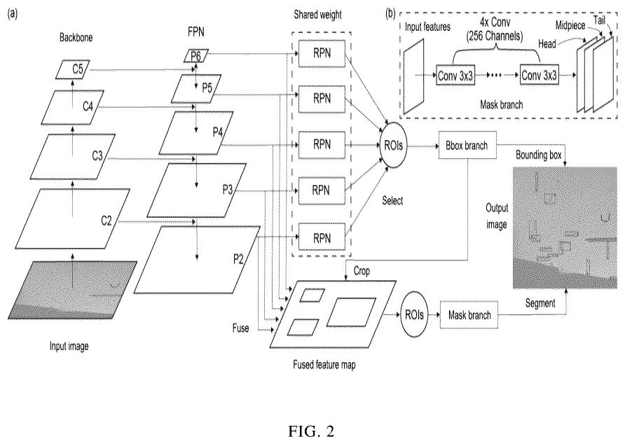

Referring to FIG. 2, specifically, the sperm parsing CNN includes a detection module and a segmentation module.

The detection module is configured to extract features from the image using a convolutional backbone architecture (swin transformer or convnet 2020), and scale sizes of the extracted features using an FPN to generate scaled feature maps, and is further configured to propose various candidate bounding boxes for the scaled feature maps using an RPN, and pass proposed ROIs to a bounding box branch for bounding box regression.

The segmentation module is configured to fuse the scaled feature maps to generate a fused feature map, crop a corresponding region in the fused feature map using a bounding box calculated by the bounding box branch, and finally input the cropped region in the fused feature map into a mask branch for part segmentation to segment the head, the midpiece, and the tail of the sperm cell.

To achieve the objective of instance-aware part segmentation (i.e., segmentation of a head, a midpiece, and a tail rather than a whole sperm cell), compared with a classical two-stage instance segmentation network, the sperm parsing CNN proposed in the present invention incorporates two critical modifications: First, the mask branch is reconfigured to generate three output channels, which respectively correspond to masks for the head, the midpiece, and the tail). In addition, labels used for recording annotations are modified correspondingly to store mask information of the head, the midpiece, and the tail. Next, instead of using a specific feature map layer (assigned based on a size of a target object) as an input to the mask branch, the network fuses all feature maps generated by the FPN, and uses a fused feature map as an input to the mask branch. Compared with segmenting a sperm cell as a whole, segmenting each part (especially the midpiece) of the sperm cell requires finer-scale analysis and a higher resolution. A fused feature map with an optimal resolution can be obtained by combining various feature maps generated by the FPN, thereby improving segmentation. In addition, ROIs for the input features of the mask branch are expanded to provide features with higher resolutions.

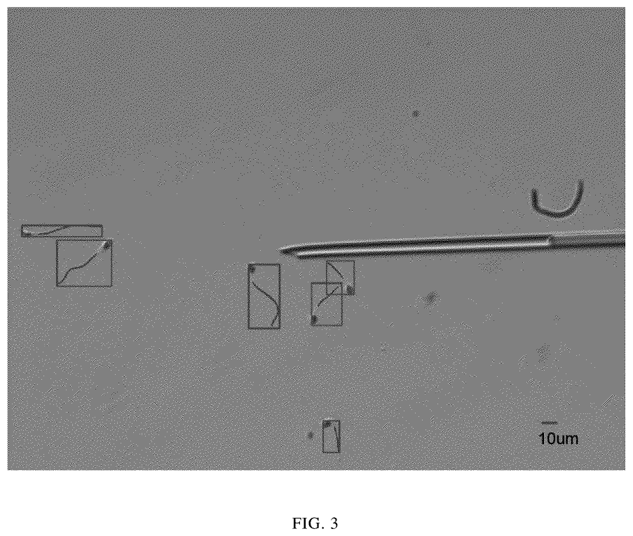

FIG. 3 is a sample image of a segmentation result of a head, a midpiece, and a tail of a sperm cell according to an embodiment of the present invention.

The morphological parameters of the sperm cell include a size of the head of the sperm cell, ellipticity of the head of the sperm cell, regularity of the head of the sperm cell, a size of the midpiece of the sperm cell, a bending angle of the midpiece of the sperm cell, an angle between the head and the midpiece of the sperm cell, a length of the tail of the sperm cell, and a degree of deformities of the tail of the sperm cell, and the like.

Optionally, a contour of the head of the sperm cell is fitted to generate an ellipse, lengths of a major axis and a minor axis of the fitted ellipse respectively represent a length and a width of the head of the sperm cell, and the size of the head of the sperm cell is obtained based on the length and the width of the head of the sperm cell; the regularity of the head of the sperm cell is calculated using a mean value of all distances between all points on the contour of the head of the sperm cell and the fitted ellipse.

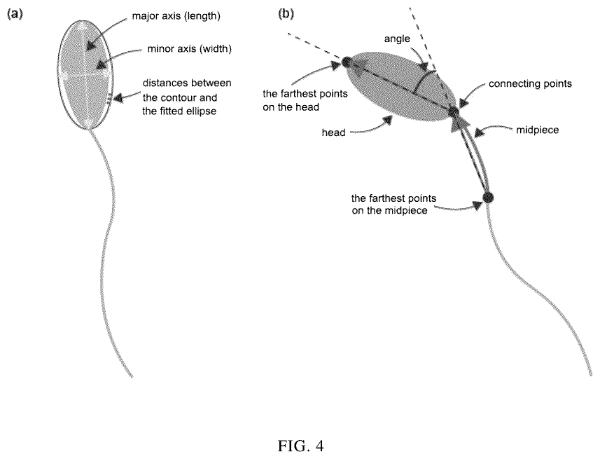

Referring to FIG. 4, optionally, a width of the midpiece of the sperm cell is obtained by calculating a mean distance from all points on a contour of the midpiece to a corresponding centerline.

Tangential directions of line segments on the centerline of the midpiece are calculated, and then a maximum variation quantity of tangential directions of adjacent line segments is calculated as the bending angle of the midpiece.

A distance from each point on the contour of the head of the sperm cell to each point on the contour of the midpiece of the sperm cell is first calculated; then a pair of closest points is found on the contour of the head of the sperm cell and the contour of the midpiece of the sperm cell and designated as connecting points; distances from the points on the contour of the head of the sperm cell and the points on the contour of the midpiece of the sperm cell to the connecting points are calculated, and farthest points are recorded; connecting lines between the connecting points and the farthest points on the head of the sperm cell and the midpiece of the sperm cell are respectively calculated, and an angle between the two lines is calculated as the angle between the head of the sperm cell and the midpiece of the sperm cell.

The deformities of the tail of the sperm cell include tail coiling, tail bending, and width nonuniformity.

The tail coiling is detected by examining width irregularities of a contour of the tail.

The tail bending is detected by examining a maximum variation of tangential directions of adjacent sections on a centerline of the tail.

The width nonuniformity is detected by measuring a distribution of distances between all points on the contour of the tail of the sperm cell to the centerline of the tail.

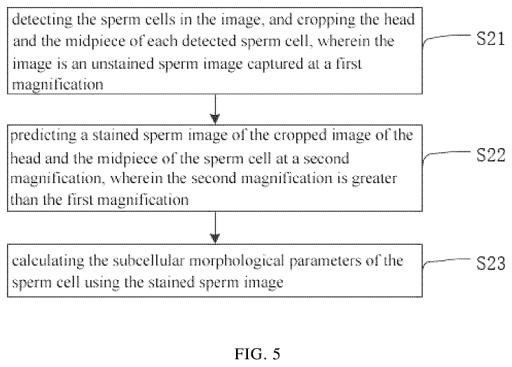

Referring to FIG. 5, in another embodiment, the method for accurately measuring live sperm morphology of the present invention further includes steps of noninvasively measuring subcellular morphological parameters of the sperm cell, where the steps include:

S21. Detect the sperm cells in the image, and crop the head and the midpiece of each detected sperm cell, where the image is an unstained sperm image captured at a first magnification.

Optionally, the sperm cells in the image are detected through the sperm parsing CNN in Step S12, and the head and the midpiece of each detected sperm cell are cropped.

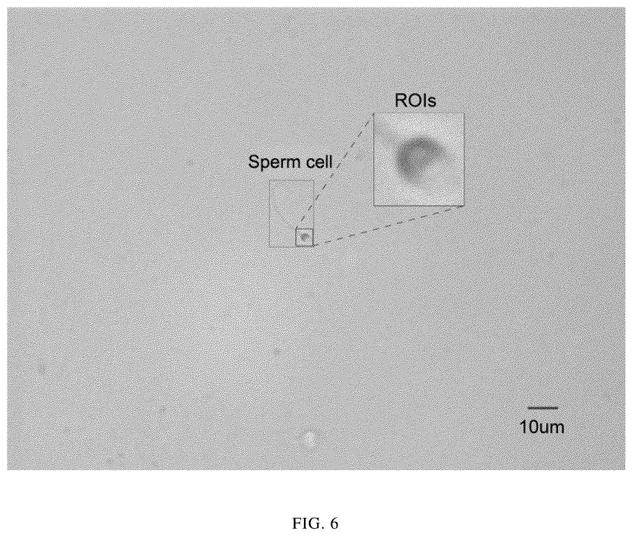

Because the subcellular structures such as the nucleus, the acrosome, and the vacuole are all within the head of the sperm cell, only the head and the midpiece of the sperm cell are cropped as an input to a sperm virtual staining GAN, to reduce an image size and time consumption for image prediction. FIG. 6 is a cropped image of a head and a midpiece of the sperm cell according to one of the embodiments.

S22. Predict a stained sperm image of the cropped image of the head and the midpiece of the sperm cell at a second magnification, where the second magnification is greater than the first magnification.

S23. Calculate the subcellular morphological parameters of the sperm cell using the stained sperm image.

In current clinical practice, visualization of subcellular structures of a sperm cell requires a high magnification and invasive staining. However, live sperm exhibit rapid motility and can easily move out of a small field of view at a high magnification, and invasive staining procedures render sperm nonviable for therapeutic use. Existing deep neural network-based methods can only predict super-resolution images or stained images. Therefore, the present invention proposes a sperm virtual staining GAN, which can implement super-resolution prediction and accomplish stain prediction, thereby enabling the measurement of subcellular morphological parameters at a low magnification without invasive staining procedures.

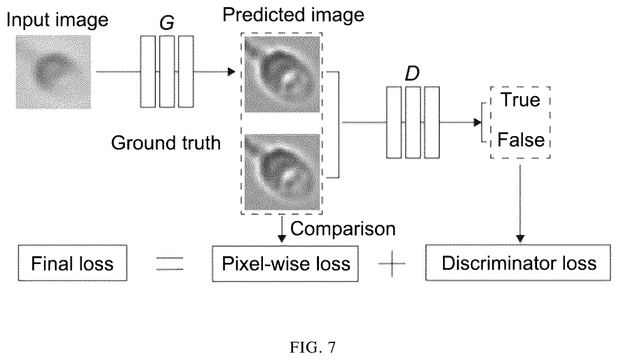

Optionally, Step S22 includes: predicting the stained sperm image of the cropped image of the head and the midpiece of the sperm cell at the second magnification using a sperm virtual staining GAN, where the sperm virtual staining GAN includes a generative model and a discriminative model, the generative model is configured to generate a synthetic stained sperm image at the second magnification using the unstained sperm image captured at the first magnification, and the discriminative network is configured to evaluate whether the image is correctly synthesized. A network training loss includes a pixel-wise loss calculated through comparison between predicted images generated by the generative network and ground truth images and a discriminator loss produced by the discriminative network. Refer to FIG. 7.

The unstained sperm image captured at the first magnification is used as an input, and is interpolated to a same resolution during training and prediction, and the stained sperm image at the second magnification is used as an output.

To train the sperm virtual staining GAN, a cropped input image at a low magnification is first interpolated to a high-magnification image with the same resolution. For example, if an input image is captured under a 20× microscope objective and an output image is captured at a 100× microscope magnification, the input image is linearly interpolated to match the resolution of the output image. The output image is a corresponding stained sperm image at a high magnification. After the input image is interpolated to the resolution same as that of the output image, the input image and the output image are registered using normalized cross-correlation, and corresponding regions are cropped. Finally, the GAN is trained using the images corresponding to the same sperm cell.

For prediction of the sperm virtual staining GAN, an image that includes a head and a midpiece of a sperm cell is first interpolated using an interpolation ratio same as that in a training process. The interpolated image is then inputted into the trained generative model to generate a predicted image.

Optionally, the first magnification ranges from 20× to 40×, and the second magnification is greater than or equal to 100×.

The subcellular morphological parameters include an acrosome area, a nucleus area, a vacuole number, and a vacuole area. The acrosome area and the nucleus area are detected through a variation in pixel intensity. Due to a significant contrast difference between an acrosome and a nucleus, the acrosome and the nucleus can be differentiated using methods such as threshold segmentation and morphological segmentation. The vacuole number and the vacuole area may be measured using pore detection algorithms such as Hough Transform and template matching.

In another embodiment, the method for accurately measuring live sperm morphology of the present invention further includes: classifying the subcellular morphological parameters of the sperm cell as normal or abnormal based on a CNN classification network without performing staining prediction, where the CNN classification network uses the unstained sperm image captured at the first magnification as an input, and uses a Boolean label indicating that the subcellular morphological parameters of the sperm cell are normal or abnormal as an output, and the Boolean label is generated based on the stained sperm image at the second magnification, and corresponds to the inputted unstained sperm image at the first magnification.

Although subcellular structures can be measured by predicting a stained sperm image at a high magnification using an unstained sperm image at a low magnification, a prediction process increases total time costs. Therefore, in the steps of noninvasively measuring the subcellular morphological parameters of the sperm cell provided in the present invention, the subcellular structures of the sperm cell are classified as normal or abnormal using the CNN classification network without performing staining prediction.

First, in an image captured at a first microscope magnification, a head and a midpiece of each sperm cell are automatically localized and cropped. Then whether subcellular morphological parameters of the inputted sperm cell are normal are classified using the CNN classification network (e.g., a swin transformer).

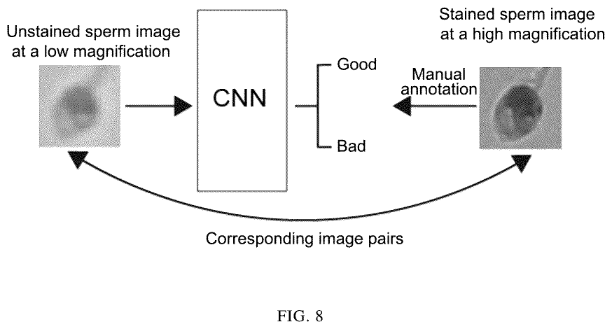

FIG. 8 is a schematic diagram of a training process of classifying subcellular morphology using unstained sperm at a first magnification according to one of the embodiments. An input of the CNN classification network is an unstained sperm image captured at a low magnification, and an output is a Boolean label generated based on a stained sperm image at a high magnification corresponding to the input. The label is generated by measuring the subcellular morphological parameters and subsequently performing manual annotation based on the measured parameters.

A preferred embodiment of the present invention further discloses an electronic device, including a memory, a processor, and a computer program stored in the memory and configured to be executed by the processor, where the processor, when executing the program, implements the steps of the method in the foregoing embodiment.

A preferred embodiment of the present invention further discloses a computer-readable storage medium, storing a computer program, where the program, when being executed by a processor, implements the steps of the method in the foregoing embodiment.

The foregoing embodiments are merely preferred embodiments used to fully describe the present invention, and the protection scope of the present invention is not limited thereto. Equivalent replacements or variations made by a person skilled in the art to the present invention all fall within the protection scope of the present invention. The protection scope of the present invention is as defined in the claims.

1. A method for accurately measuring live sperm morphology, comprising steps of:
S11. acquiring an image comprising a plurality of sperm cells;
S12. detecting the sperm cells in the image, and segmenting a head, a midpiece, and a tail of each detected sperm cell; and
S13. calculating morphological parameters of each sperm cell based on a segmentation result.

2. The method for accurately measuring live sperm morphology according to claim 1, wherein Step S12 comprises: detecting the sperm cells in the image using a sperm parsing convolutional neural network (CNN), and segmenting the head, the midpiece, and the tail of each detected sperm cell, wherein the sperm parsing CNN comprises a detection module and a segmentation module;
the detection module is configured to extract features from the image using a convolutional backbone architecture, and scale sizes of extracted features using a feature pyramid network (FPN) to generate scaled feature maps, and is further configured to propose various candidate bounding boxes for the scaled feature maps using a region proposal network (RPN), and pass proposed regions of interest (ROIs) to a bounding box branch for bounding box regression; and
the segmentation module is configured to fuse the scaled feature maps to generate a fused feature map, crop a corresponding region in the fused feature map using a bounding box calculated by the bounding box branch, and finally input a cropped region in the fused feature map into a mask branch for part segmentation to segment the head, the midpiece, and the tail of the sperm cell.

3. The method for accurately measuring live sperm morphology according to claim 1, wherein the morphological parameters of the sperm cell comprise a size of the head of the sperm cell, ellipticity of the head of the sperm cell, regularity of the head of the sperm cell, a size of the midpiece of the sperm cell, a bending angle of the midpiece of the sperm cell, an angle between the head and the midpiece of the sperm cell, a length of the tail of the sperm cell, and a degree of deformities of the tail of the sperm cell.

4. The method for accurately measuring live sperm morphology according to claim 3, wherein a contour of the head of the sperm cell is fitted to generate an ellipse, lengths of a major axis and a minor axis of the fitted ellipse respectively represent a length and a width of the head of the sperm cell, and the size of the head of the sperm cell is obtained based on the length and the width of the head of the sperm cell; the regularity of the head of the sperm cell is calculated using a mean value of all distances between all points on the contour of the head of the sperm cell and the fitted ellipse;
a width of the midpiece of the sperm cell is obtained by calculating a mean distance from all points on a contour of the midpiece to a corresponding centerline;
tangential directions of line segments on the centerline of the midpiece are calculated, and then a maximum variation quantity of tangential directions of adjacent line segments is calculated as the bending angle of the midpiece;
a distance from each point on the contour of the head of the sperm cell to each point on the contour of the midpiece of the sperm cell is first calculated; then a pair of closest points is found on the contour of the head of the sperm cell and the contour of the midpiece of the sperm cell and designated as connecting points; distances from the points on the contour of the head of the sperm cell and the points on the contour of the midpiece of the sperm cell to the connecting points are calculated, and farthest points are recorded; connecting lines between the connecting points and the farthest points on the head of the sperm cell and the midpiece of the sperm cell are respectively calculated, and an angle between two lines is calculated as the angle between the head of the sperm cell and the midpiece of the sperm cell; and
the deformities of the tail of the sperm cell comprise tail coiling, tail bending, and width nonuniformity; the tail coiling is detected by examining width irregularities of a contour of the tail; the tail bending is detected by examining a maximum variation of tangential directions of adjacent sections on a centerline of the tail; and the width nonuniformity is detected by measuring a distribution of distances between all points on the contour of the tail of the sperm cell to the centerline of the tail.

5. The method for accurately measuring live sperm morphology according to claim 1, further comprising noninvasively measuring subcellular morphological parameters of the sperm cell, including:
S21. detecting the sperm cells in the image, and cropping the head and the midpiece of each detected sperm cell, wherein the image is an unstained sperm image captured at a first magnification;
S22. predicting a stained sperm image of the cropped image of the head and the midpiece of the sperm cell at a second magnification, wherein the second magnification is greater than the first magnification; and
S23. calculating the subcellular morphological parameters of the sperm cell using the stained sperm image.

6. The method for accurately measuring live sperm morphology according to claim 5, wherein Step S22 comprises: predicting the stained sperm image of the cropped image of the head and the midpiece of the sperm cell at the second magnification using a sperm virtual staining generative adversarial network (GAN), wherein the sperm virtual staining GAN comprises a generative model and a discriminative model, the generative model is configured to generate a synthetic stained sperm image at the second magnification using the unstained sperm image captured at the first magnification, and the discriminative network is configured to evaluate whether the image is correctly synthesized.

7. The method for accurately measuring live sperm morphology according to claim 5, wherein the unstained sperm image captured at the first magnification is used as an input, and is interpolated to a same resolution during training and prediction, and the stained sperm image at the second magnification is used as an output.

8. The method for accurately measuring live sperm morphology according to claim 5, wherein the first magnification ranges from 20× to 40×, and the second magnification is greater than or equal to 100×.

9. The method for accurately measuring live sperm morphology according to claim 5, wherein the subcellular morphological parameters comprise an acrosome area, a nucleus area, a vacuole number, and a vacuole area, the acrosome area and the nucleus area are detected through a variation in pixel intensity, and the vacuole number and the vacuole area are detected using a pore detection algorithm.

10. The method for accurately measuring live sperm morphology according to claim 5, further comprising: classifying the subcellular morphological parameters of the sperm cell as normal or abnormal based on a CNN classification network without performing staining prediction, wherein the CNN classification network uses the unstained sperm image captured at the first magnification as an input, and uses a Boolean label indicating that the subcellular morphological parameters of the sperm cell are normal or abnormal as an output, and the Boolean label is generated based on the stained sperm image at the second magnification, and corresponds to the inputted unstained sperm image at the first magnification.
